(19) United States
(12) Patent Application Publication
(10) Pub. No.: US 2024/0165535 A1
(43) Pub. Date: May 23, 2024

(54) FRACTIONAL DISTILLATION SYSTEM AND METHOD

(71) Applicant: ENTEGRIS, INC., Billerica, MA (US)

(72) Inventors: Peter Litak, Schwenksville, PA (US); Harry S. Thompson, Philadelphia, PA (US)

(21) Appl. No.: 18/384,014

(22) Filed: Oct. 26, 2023

Related U.S. Application Data
(60) Provisional application No. 63/425,594, filed on Nov. 15, 2022.

(51) Int. Cl. B01D 3/32; B01D 3/10; B01D 3/42; C07F 17/00

(52) U.S. Cl. CPC B01D 3/32; B01D 3/10; B01D 3/4216; C07F 17/00

(57) ABSTRACT

An apparatus includes a distillation container configured to receive a mixture. The apparatus includes a column fluidly connected to the distillation container. A mesh is disposed in the column. The apparatus includes a plurality of conduits fluidly connected to respective vacuums. A fractionating head is fluidly connected to the column. The column is fluidly connected between the distillation container and the fractionating head.

### FIELD

The present disclosure relates to the field of distillation. More specifically, the present disclosure relates to system and methods for fractional distillation.

### BACKGROUND

Fractional distillation is a technique for separating individual components or constituents that make up a mixture or composition. Fractional distillation leverages that each constituent making up the composition or mixture (made up of several different constituents) has a unique boiling or vaporization point that is different than the boiling point of the other constituents making up the composition.

### SUMMARY

In some embodiments, an apparatus includes a distillation container configured to receive a mixture. In some embodiments, the apparatus includes a column fluidly connected to the distillation container. In some embodiments, a mesh is disposed in the column. In some embodiments, the apparatus includes a plurality of conduits fluidly connected to respective vacuums. In some embodiments, a fractionating head is fluidly connected to the column. In some embodiments, the column is fluidly connected between the distillation container and the fractionating head.

In some embodiments, the fractionating head comprises a magnetically activated diverter.

In some embodiments, the magnetically activated diverter is configured to be controlled by a timer.

In some embodiments, the apparatus includes a pressure relief valve.

In some embodiments, the apparatus includes a collection container configured to receive a first fraction of the mixture.

In some embodiments, a first of the plurality of conduits is fluidly connected to the fractionating head.

In some embodiments, the mesh is made of a corrosion resistant metal. In some embodiments, the corrosion resistant metal comprises at least one of stainless steel, corrosion-resistant nickel alloys, or combinations thereof.

In some embodiments, a method includes obtaining a liquid mixture. In some embodiments, the method includes separating the liquid mixture by heating the liquid mixture in a distillation container. In some embodiments, the separating includes flowing a vapor of the liquid mixture into contact with a column having a mesh and through a fractionating head fluidly connected to the column. In some embodiments, the method includes collecting a first fraction of the liquid mixture as separated.

In some embodiments, the method includes controlling the fractionating head via a timer to control the separating.

In some embodiments, the fractionating head includes a magnetically activated diverter controlled by the timer.

In some embodiments, the method includes collecting a second fraction of the liquid mixture as separated.

In some embodiments, the method includes evacuating the fractionating head via a plurality of conduits fluidly connected to respective vacuums.

In some embodiments, the liquid mixture includes a compound of the formula:

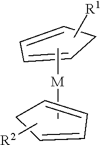

wherein: R¹ and R² are each independently a hydrogen, a linear alkyl, or a branched alkyl, and wherein M is a metal.

In some embodiments, an apparatus includes a distillation container configured to receive a liquid mixture comprising a compound of the formula:

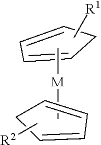

wherein R¹ and R² are each independently a hydrogen, a linear alkyl, or a branched alkyl, and wherein M is a metal. In some embodiments, the apparatus includes a column fluidly connected to the distillation container and configured to receive a vapor from the distillation container. In some embodiments, the apparatus includes a corrosion resistant mesh disposed in the column. In some embodiments, the apparatus includes a plurality of conduits fluidly connected to respective vacuums. In some embodiments, the apparatus includes a magnetically activated diverter fluidly connected to the column and configured to receive the vapor from the column.

In some embodiments, the magnetically activated diverter is configured to be controlled by a timer.

In some embodiments, the apparatus includes a collection container configured to receive a first fraction of the liquid mixture.

In some embodiments, a first of the plurality of conduits is fluidly connected to the magnetically activated diverter.

In some embodiments, the corrosion resistant mesh is made of a corrosion resistant metal.

In some embodiments, the corrosion resistant metal includes at least one of stainless steel, corrosion-resistant nickel alloys, or combinations thereof.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 shows a fractional distillation system, according to some embodiments.

FIG. 2 shows a flowchart of a method for fractional distillation, according to some embodiments.

### DETAILED DESCRIPTION

Fractional distillation is a technique for separating individual components or constituents that make up a mixture or composition. Fractional distillation leverages that each constituent making up the composition or mixture (made up of several different constituents) has a unique boiling or vaporization point that is different than the boiling point of the other constituents making up the composition. Existing fractional distillation systems may be inefficient, unable to meet purity requirements, or inefficient and unable to meet purity requirements. Embodiments of this disclosure relate to improved fractional distillation systems which, in some embodiments, are efficient and able to meet purification requirements for distilling a liquid mixture.

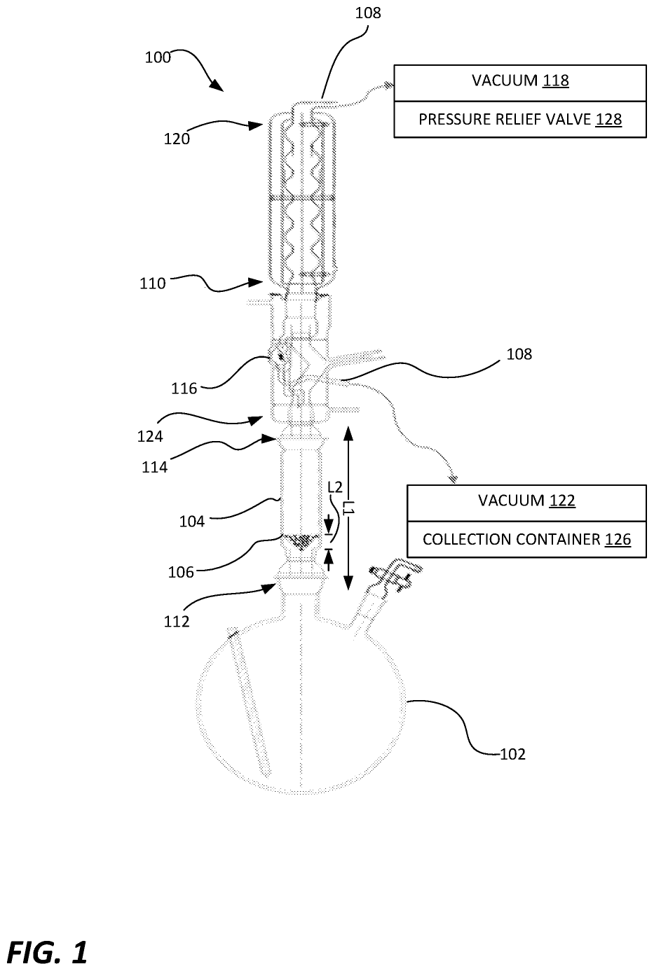

FIG. 1 shows a fractional distillation system 100, according to some embodiments. The fractional distillation system 100 includes a distillation container 102, a column 104, a mesh 106, a plurality of conduits 108 configured to be fluidly connected to respective vacuums, and a fractionating head 110.

In some embodiments, the distillation container 102 is configured to receive a mixture, such as a liquid mixture. In some embodiments, the distillation container 102 can be, for example, a round-bottom flask, an Erlenmeyer flask, or similar container capable of receiving a liquid mixture and being heated. In some embodiments, the heat can be applied by, for example, a Bunsen burner or the like. It is to be appreciated that this is an example, and that the manner by which heat is applied to the distillation container 102 is not intended to be limiting.

The column 104 is fluidly connected to the distillation container 102 at a first end 112, according to some embodiments. The column 104 is fluidly connected to the fractionating head 110 at a second end 114, according to some embodiments. Between the first end 112 and the second end 114, the column 104 includes the mesh 106.

In some embodiments, the column 104 has a length L1. The length L1 can be selected based on, for example, a particular application of the liquid mixture being fractionated.

In some embodiments, the mesh 106 spans a length L2. In some embodiments, the length L2 is less than the length L1. In some embodiments, the length L2 can be selected based on, for example, a particular application of the liquid mixture being fractionated. In some embodiments, the length L2 can be selected based on the length L2.

In some embodiments, the mesh 106 is formed of a corrosion resistant metal. In some embodiments, the corrosion resistant metal includes at least one of stainless steel, corrosion-resistant nickel alloys, or combinations thereof. It is to be appreciated that these materials are examples. In some embodiments, a non-metal material may be utilized for the mesh 106. For example, in some embodiments, the mesh can be made of a glass, ceramic, combinations thereof, or the like.

In some embodiments, the mesh 106 can have a high surface area and a high void fraction. As a result, in some embodiments, the high surface area and high void fraction can provide for a low pressure drop across the column. As a result, in some embodiments, the column length and separation efficiency may be increased without increasing a temperature required for the distillation container 102 to be heated to for the distillation to occur.

In some embodiments, the mesh 106 can be formed of a plurality of flat ribbons of material. In some embodiments, the flat ribbons of material may be the corrosion resistant metal or other materials such as glass, ceramic, combinations thereof, or the like. In some embodiments, the configuration including flat ribbons of material woven together can increase a surface area of the mesh 106 compared to a volume of the mesh 106 (i.e., increase a surface area to volume ratio). It is to be appreciated that the geometry is an example, and that other geometries, such as tubular or the like can be used according to the principles described in this Specification.

The fractionating head 110 is fluidly connected to the second end 114 of the column 104. The fractionating head 110 includes a flow diverter 116, according to some embodiments. In some embodiments, the flow diverter 116 is a magnetically activated flow diverter. A magnetically activated flow diverter can reduce variability between distillations and provide better reproducibility based on the control of the magnetically activated flow diverter. The fractionating head 110 can include a timer to dictate a position of the flow diverter 116. In some embodiments, the timer can be part of the flow diverter 116. In some embodiments, the timer can be configured to be in electronic communication with the flow diverter 116 such that the flow diverter changes position upon completion of the timer.

In some embodiments, the fractional distillation system 100 is configured to receive a liquid mixture for distillation. In some embodiments, the liquid mixture includes a compound of the formula:

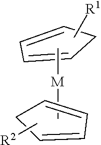

wherein R¹ and R² are each independently a hydrogen, a linear alkyl, or a branched alkyl and where M is a metal. In some embodiments, the metal is tungsten. It is to be appreciated that the fractional distillation system 100 may be utilized to distill a liquid mixture having compounds other than the above example.

The fractional distillation system 100 includes the conduits 108 fluidly connected to respective vacuums. A first vacuum 118 is fluidly connected to a first of the conduits 108 disposed at an end 120 of the fractionating head 110. A second vacuum 122 is fluidly connected to a second of the conduits 108 disposed at an end 124 of the fractionating head 110. In some embodiments, the second vacuum 122 is fluidly connected adjacent to the flow diverter 116. In some embodiments, the conduits 108 are wide bore conduits. In some embodiments, a wide bore conduit includes a conduit having a sufficient diameter relative to a size of the fractional distillation system 100 to compensate for outgas. In some embodiments, a wide bore conduit can have a diameter of at least 0.5 inches for a fractional distillation system 100 having a capacity of 12 L.

In some embodiments, a collection container 126 is fluidly connected to the fractionating head 110. In some embodiments, more than one of the collection container 126 can be included such as, for example, to collect multiple fractions from the liquid mixture being distilled.

In some embodiments, a pressure relief valve 128 is fluidly connected to the fractionating head 110 at the end 120.

In some embodiments, including the plurality of conduits 108 fluidly connected to respective vacuums can shorten time needed to evacuate the fractional distillation system 100, which can, for example, reduce startup times for usage of the fractional distillation system 100. In some embodiments, the plurality of conduits 108 can reduce an amount of time for the vacuum to recover in an instance in which the operation of the vacuums is disrupted. In some embodiments, the plurality of conduits 108 and fluidly connected to respective vacuums can enable a stable distillation procedure with no cycling in the distillation rate.

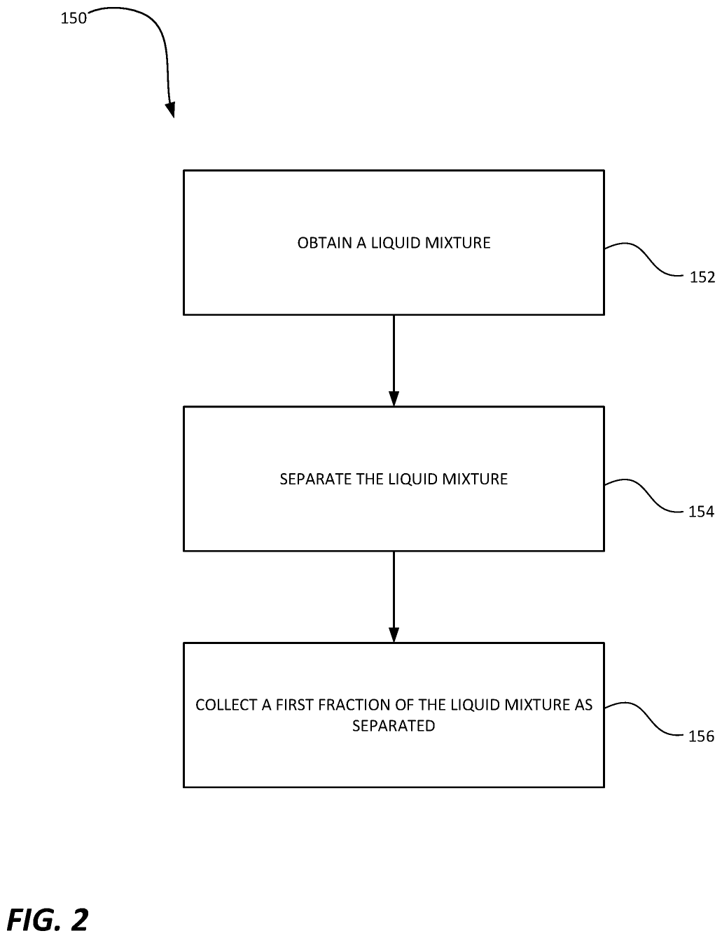

FIG. 2 shows a flowchart of a method 150 for fractional distillation, according to some embodiments. In some embodiments, the method 150 can be performed using the fractional distillation system 100 of FIG. 1.

At block 152, the method 150 includes obtaining a liquid mixture. In some embodiments, the liquid mixture includes a compound of the formula:

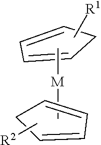

R¹ and R² are each independently a hydrogen, a linear alkyl, or a branched alkyl. M is a metal. In some embodiments, the metal is tungsten.

At block 154, the method 150 includes separating the liquid mixture by heating the liquid mixture in a distillation container (e.g., the distillation container 102 of FIG. 1). In some embodiments, the separating includes flowing a vapor of the liquid mixture into contact with a column (e.g., the column 104 of FIG. 1) having a mesh (e.g., the mesh 106 of FIG. 1) and through a fractionating head (e.g., the fractionating head 110 of FIG. 1) fluidly connected to the column. In some embodiments, the fractionating head includes a timer and a magnetically activated diverter to control the fractionating head. In some embodiments, the timer is used to control the magnetically activated diverter.

At block 156, the method 150 includes collecting a first fraction of the liquid mixture as separated. Optionally, in some embodiments, a second fraction of the liquid mixture as separated can be collected. It is to be appreciated that one or more additional fractions of the liquid mixture can also be collected.

In some embodiments, the fractional distillation system can be evacuated using a plurality of wide bore vacuums. In some embodiments, including the plurality of wide bore vacuums can enable a faster evacuation of the distillation chamber than prior methods.

Aspects

Various Aspects are described below. It is to be understood that any one or more of the features recited in the following Aspect(s) can be combined with any one or more other Aspect(s).

Aspect 1. An apparatus, comprising: a distillation container configured to receive a mixture; a column fluidly connected to the distillation container; a mesh disposed in the column; a plurality of conduits fluidly connected to respective vacuums; and a fractionating head fluidly connected to the column, wherein the column is fluidly connected between the distillation container and the fractionating head.

Aspect 2. The apparatus of aspect 1, wherein the fractionating head comprises a magnetically activated diverter.

Aspect 3. The apparatus of aspect 2, wherein the magnetically activated diverter is configured to be controlled by a timer.

Aspect 4. The apparatus of any one of aspects 1-3, comprising a pressure relief valve.

Aspect 5. The apparatus of any one of aspects 1-4, a collection container configured to receive a first fraction of the mixture.

Aspect 6. The apparatus of any one of aspects 1-5, wherein a first of the plurality of conduits fluidly connected to respective vacuums is fluidly connected to the fractionating head.

Aspect 7. The apparatus of any one of aspects 1-6, wherein the mesh is made of a corrosion resistant metal.

Aspect 8. The apparatus of aspect 7, wherein the corrosion resistant metal comprises at least one of stainless steel, corrosion-resistant nickel alloys, or combinations thereof.

Aspect 9. A method, comprising: obtaining a liquid mixture; separating the liquid mixture by heating the liquid mixture in a distillation container, wherein the separating comprises flowing a vapor of the liquid mixture into contact with a column having a mesh and through a fractionating head fluidly connected to the column; and collecting a first fraction of the liquid mixture as separated.

Aspect 10. The method of aspect 9, comprising controlling the fractionating head via a timer to control the separating.

Aspect 11. The method of aspect 10, wherein the fractionating head comprises a magnetically activated diverter controlled by the timer.

Aspect 12. The method of one of aspect 10 or 11, comprising collecting a second fraction of the liquid mixture as separated.

Aspect 13. The method of any one of aspects 10-12, comprising evacuating the fractionating head via a plurality of conduits fluidly connected to respective vacuums.

Aspect 14. The method of any one of aspects 10-13, wherein the liquid mixture comprises a compound of the formula:

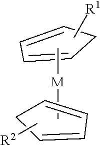

wherein: R¹ and R² are each independently a hydrogen, a linear alkyl, or a branched alkyl; and M is a metal.

Aspect 15. An apparatus, comprising: a distillation container configured to receive a liquid mixture comprising a compound of the formula:

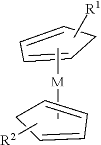

wherein R¹ and R² are each independently a hydrogen, a linear alkyl, or a branched alkyl; and wherein M is a metal; a column fluidly connected to the distillation container and configured to receive a vapor from the distillation container; a corrosion resistant mesh disposed in the column; a plurality of conduits fluidly connected to respective vacuums; and a magnetically activated diverter fluidly connected to the column and configured to receive the vapor from the column.

Aspect 16. The apparatus of aspect 15, wherein the magnetically activated diverter is configured to be controlled by a timer.

Aspect 17. The apparatus of one of aspects 15 or 16, a collection container configured to receive a first fraction of the liquid mixture.

Aspect 18. The apparatus of any one of aspects 15-17, wherein a first of the plurality of conduits fluidly connected to respective vacuums is fluidly connected to the magnetically activated diverter.

Aspect 19. The apparatus of any one of aspects 15-18, wherein the corrosion resistant mesh is made of a corrosion resistant metal.

Aspect 20. The apparatus of aspect 19, wherein the corrosion resistant metal comprises at least one of stainless steel, corrosion-resistant nickel alloys, or combinations thereof.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. An apparatus, comprising:
a distillation container configured to receive a mixture;
a column fluidly connected to the distillation container;
a mesh disposed in the column;
a plurality of conduits fluidly connected to respective vacuums; and
a fractionating head fluidly connected to the column,
wherein the column is fluidly connected between the distillation container and the fractionating head.

2. The apparatus of claim 1, wherein the fractionating head comprises a magnetically activated diverter.

3. The apparatus of claim 2, wherein the magnetically activated diverter is configured to be controlled by a timer.

4. The apparatus of claim 1, comprising a pressure relief valve.

5. The apparatus of claim 1, a collection container configured to receive a first fraction of the mixture.

6. The apparatus of claim 1, wherein a first of the plurality of conduits fluidly connected to respective vacuums is fluidly connected to the fractionating head.

7. The apparatus of claim 1, wherein the mesh is made of a corrosion resistant metal.

8. The apparatus of claim 7, wherein the corrosion resistant metal comprises at least one of stainless steel, corrosion-resistant nickel alloys, or combinations thereof.

9. A method, comprising:
obtaining a liquid mixture;
separating the liquid mixture by heating the liquid mixture in a distillation container,
wherein the separating comprises flowing a vapor of the liquid mixture into contact with a column having a mesh and through a fractionating head fluidly connected to the column; and
collecting a first fraction of the liquid mixture as separated.

10. The method of claim 9, comprising controlling the fractionating head via a timer to control the separating.

11. The method of claim 10, wherein the fractionating head comprises a magnetically activated diverter controlled by the timer.

12. The method of claim 10, comprising collecting a second fraction of the liquid mixture as separated.

13. The method of claim 10, comprising evacuating the fractionating head via a plurality of conduits fluidly connected to respective vacuums.

14. The method of claim 10, wherein the liquid mixture comprises a compound of the formula: 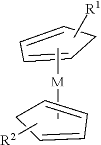
wherein:
R¹ and R² are each independently a hydrogen, a linear alkyl, or a branched alkyl, and
M is a metal.

15. An apparatus, comprising:
a distillation container configured to receive a liquid mixture comprising a compound of the formula: 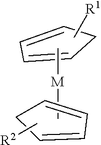
wherein R¹ and R² are each independently a hydrogen, a linear alkyl, or a branched alkyl; and
wherein M is a metal;
a column fluidly connected to the distillation container and configured to receive a vapor from the distillation container;
a corrosion resistant mesh disposed in the column;
a plurality of conduits fluidly connected to respective vacuums; and
a magnetically activated diverter fluidly connected to the column and configured to receive the vapor from the column.

16. The apparatus of claim 15, wherein the magnetically activated diverter is configured to be controlled by a timer.

17. The apparatus of claim 15, a collection container configured to receive a first fraction of the liquid mixture.

18. The apparatus of claim 15, wherein a first of the plurality of conduits fluidly connected to respective vacuums is fluidly connected to the magnetically activated diverter.

19. The apparatus of claim 15, wherein the corrosion resistant mesh is made of a corrosion resistant metal.

20. The apparatus of claim 19, wherein the corrosion resistant metal comprises at least one of stainless steel, corrosion-resistant nickel alloys, or combinations thereof.
